(19) United States
(12) Patent Application Publication
(10) Pub. No.: US 2005/0091533 A1
(43) Pub. Date: Apr. 28, 2005

(54) Device and method for worm detection, and computer product

(75) Inventors: Kazumasa Omote, Kawasaki (JP); Satoru Torii, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 10/812,622

(22) Filed: Mar. 30, 2004

(30) Foreign Application Priority Data
Oct. 28, 2003 (JP) 2003-367272

(51) Int. Cl. H04L 9/00

(52) U.S. Cl. 713/201

(57) ABSTRACT

A communication-information acquisition section 240a acquires information related to a traffic and communication address of a communication packet based on setting information related to acquisition of information that is stored in setting-data. Worm detection section makes a judgment of whether a communication is executed by a worm based on information acquired by the communication-information acquisition section and information related to judgment criteria that is stored in the setting-data and which regulates whether the communication is executed by a worm.

### BACKGROUND OF THE INVENTION

1) Field of the Invention

The present invention relates to a technology for monitoring a communication related to a predetermined segment that is connected to a network and making a judgment of whether the communication is executed by a worm.

2) Description of the Related Art

In recent years, damage caused by computer virus called worm is increasing because the worms infect the computers one after another by repeated self-reproduction. Previously, worms used to infect computers via flexible discs (FD), CD-ROM etc. and their infective power was not so strong. However, nowadays with the spread of the Internet, the infective power has been increasing day by day and the protection against worms has become a vital issue.

To tackle this issue, a worm detection method is disclosed in Japanese Patent Application Laid-open Publication No. 2002-342106. According to the method, an object to be tested for worm is introduced in a computer environment that is created virtually and it is monitored whether the object corrupts a predetermined file.

A Web server protection system that detects an attack by a worm is disclosed in “Press Release” of NEC on the Internet URL: http://www.nec.co.jp/press/ja/0304/1101.html/ (retrieved on Oct. 28, 2003) (non-patent document). According to the Web server protection system, behavior of a server (a series of data I/O, system call etc.) upon being attacked by a worm is defined in advance as a monitoring rule. An object to be tested for infection by a worm is introduced in an access-test server and the operation of the object is monitored to detect the attack by a worm.

However, in the conventional technology disclosed in the Japanese Patent Application Laid-open Publication No. 2002-342106, the virtual computer environment in which the object is created in advance has to be introduced each time the communication is performed. Further, it is necessary to test if the virtual computer environment is infected. Therefore, it is not an efficient way to test worm detection for all communications. Even if the communications for which there is a potential danger due to a worm are tested, it is difficult to establish a standard to judge the degree of the danger involved.

In the non-patent document, the behavior of the server after being attacked by a worm is defined in advance as a monitoring rule. However, for a client device, which is used for various applications and shows various behaviors, it is difficult to define monitoring rules that distinguish between behavior after being attacked by a worm and normal behavior.

### SUMMARY OF THE INVENTION

It is an object of the present invention to at least solve the problems in the conventional technology.

A computer program for detecting a worm by monitoring a communication of a predetermined network segment that is connected to a network and judging whether the communication is executed by a worm, according to an aspect of the present invention causes a computer to perform acquiring information related to a traffic and a communication address of a communication packet based on setting information; and judging whether the communication is executed by the worm based on the information acquired and a predetermined judgment criteria.

A device for detecting a worm by monitoring a communication of a predetermined network segment that is connected to a network and judging whether the communication is executed by a worm, according to another aspect of the present invention includes an acquiring unit that acquires information related to a traffic and a communication address of a communication packet based on setting information; and a judging unit that judges whether the communication is executed by the worm based on the information acquired and a predetermined judgment criteria.

A method for detecting a worm by monitoring a communication of a predetermined network segment that is connected to a network and judging whether the communication is executed by a worm, according to still another aspect of the present invention includes acquiring information related to a traffic and a communication address of a communication packet based on setting information; and judging whether the communication is executed by the worm based on the information acquired and a predetermined judgment criteria.

A computer-readable recording medium according to still another aspect of the present invention stores the computer program according to the present invention.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a conceptual diagram of a worm detection system according to an embodiment of the present invention;

FIG. 2 is a functional block diagram of a worm detection device according to the embodiment of the present invention;

FIG. 3 is an example of contents of setting-data;

FIG. 4 is an example of contents of communication-log data;

FIG. 5 is an example of processes procedure for detecting a worm according to a type of a packet;

FIG. 6 is an example of a process procedure for judging presence of a worm scan from outside of a network segment;

FIG. 7 is an example of a process procedure for judging presence of a worm infection;

FIG. 8 is an example of a process procedure for judging presence of a worm infection by an attack from outside of the network segment;

FIG. 9 is an example of a process procedure for judging a worm infection in a plurality of computers;

FIG. 10 is an example of a process procedure for cutting off communication executed by a worm;

FIG. 11 is to explain how the worm detection device cuts off the communication executed by a worm;

FIG. 12 is to explain how the computer that is infected itself cuts off the communication executed by a worm;

FIG. 13 is a block diagram of the worm detection device according to the present invention;

FIG. 14 is a flow chart of a process procedure of a worm detection process according to the present embodiment;

FIG. 15A is a flow chart of a processing procedure of a status judgment process;

FIG. 15B is a continuation of the flow chart shown in FIG. 15A; and

FIG. 16 is a conceptual diagram of a network segment.

### DETAILED DESCRIPTION

Exemplary embodiments of a device and a method for detecting a worm, a computer program, and a computer-readable recording medium for storing the computer program according to the present invention are described in detail below with reference to accompanying drawings.

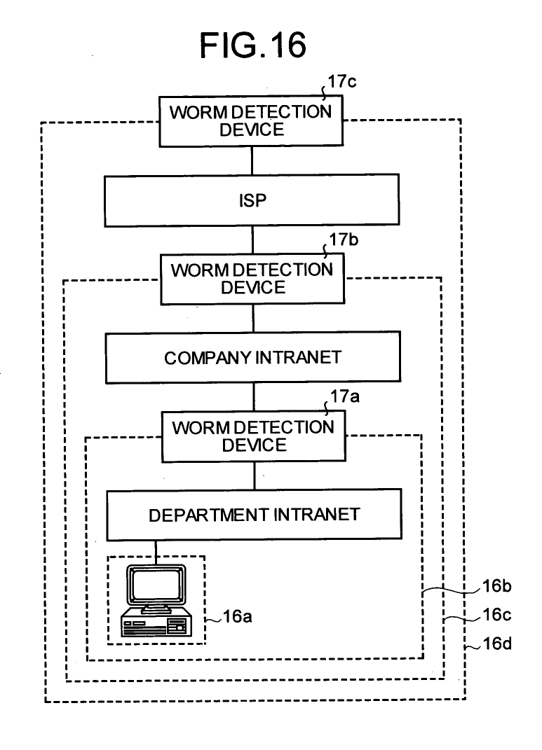

To start with, a concept of a network segment according to a present embodiment is described below. FIG. 16 is a conceptual diagram of the network segment according to the present embodiment. The network segment has a structure that includes a plurality of layers.

A network segment 16a, which is a network segment of the smallest scale, is computer to which the computer program according to the present invention is introduced. The computer monitors the communications of the network segment 16a to detect a worm. A network segment 16b, which has a scale slightly bigger than that of the network segment 16a, is structured in units of intranets of a department (department intranet). A worm detection device 17a is connected to the network segment 16b and performs a worm detection process by monitoring communication related to the network segment 16b.

A network segment 16c, which has a scale that is even bigger than the network segment 16b is structured in units of intranets of a company (company intranet). A worm detection device 17b is connected to the network segment 16c and performs a worm detection process by monitoring communication related to the network segment 16c. A network segment 16d, which has a scale that is even bigger than the network segment 16c is structured in units of ISP (Internet Service Provider). A worm detection device 17c is connected to the network segment 16d and performs a worm detection process by monitoring communication related to the network segment 16d.

Thus, the network segment can be of various scales and various forms. The worm detection system according to the present invention can be applied to network segments of various scales and various forms.

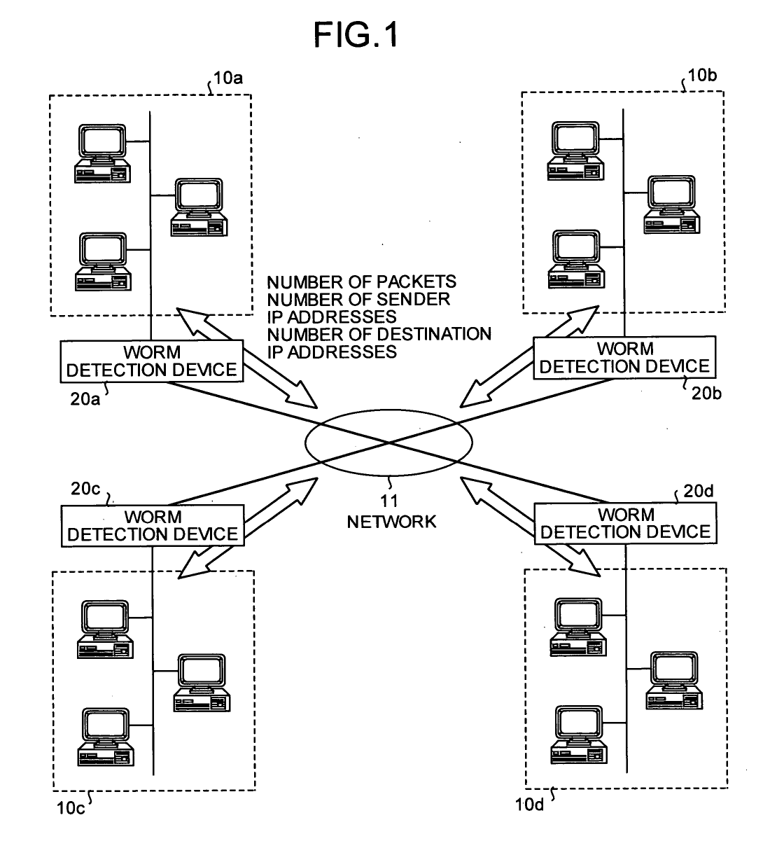

A concept of the worm detection system according to an embodiment of the present embodiment is described below. FIG. 1 is a conceptual diagram of the worm detection system according to the embodiment of the present invention. The worm detection system includes network segments 10a to 10d. Each of the network segments 10a to 10d includes at least one of a server, a client device etc. and is connected to a network 11 via worm detection devices 20a to 20d, respectively. The network 11 is a network such as the Internet, the Intranet, or the ISP network.

The worm detection devices 20a to 20d monitor communication packets which are transmitted to the network segments 10a to 10d from other network segments 10a to 10d and communication packets which the network segments 10a to 10d transmit to the other network segments 10a to 10d. The worm detection devices 20a to 20d make a judgment of whether communication by the communication packets is executed by a worm.

Concretely, the worm detection devices 20a to 20d acquire information such as number of packets per unit time, a sender IP address and a destination IP address of each communication packet etc. Based on the information acquired, a particular worm detection device makes a judgment of whether there is an attack by a worm on a corresponding network segment from other network segment. The particular worm detection device also makes a judgment of whether a computer in a network segment other than the corresponding network segment is attacked by a worm.

If a computer is infected by a worm, irrespective of whether the computer is a server or a client device, there occurs a remarkable change in the number of packets per unit time or the sender IP address and the destination IP address of each communication packet etc. Because the worm detection system according to the embodiment uses this fact to detect an attack by a worm, it becomes possible to detect the worm easily and efficiently irrespective of the type of the computer.

A judgment of whether the communication is executed by the worm is made based on the change in the information such as the number of packets per unit time of the communication packets, the sender IP address and the destination IP address of each communication packet etc. rather than the conventional approach of detecting the communication executed by a worm by referring to the features of the worm registered in advance. Therefore, an unknown worm can also be dealt with properly.

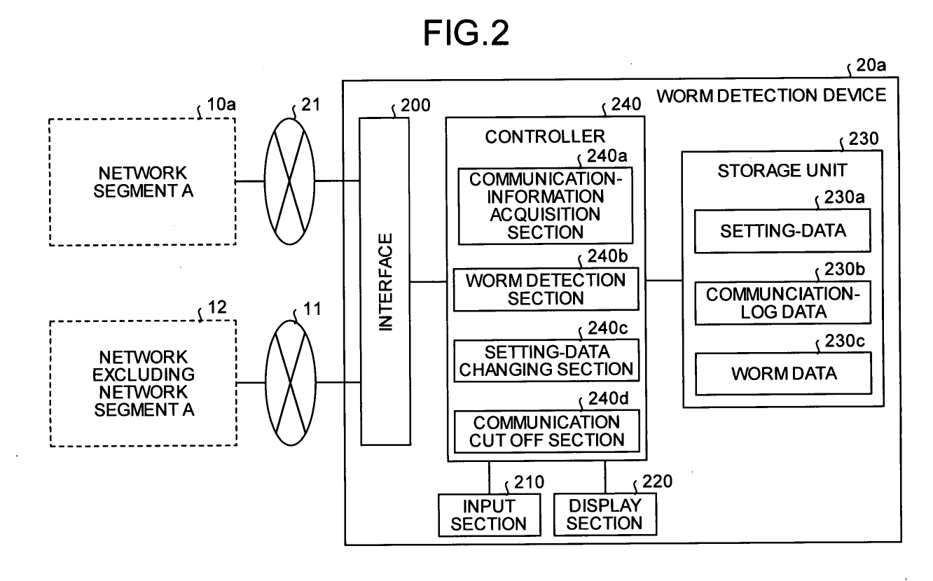

Further, a functional structure of the worm detection devices 20a to 20d according to the embodiment is described below. FIG. 2 is a functional block diagram of the worm detection device 20a. The worm detection devices 20b to 20d have the same functional structure.

As shown in FIG. 2, the worm detection device 20a is connected to a network segment A 10a via a LAN 21 and to a network 12 excluding the network segment A 10 via a network 11. The LAN 21 is a network such as the Intranet.

The worm detection device 20a acquires information of traffic and communication address of a communication packet based on setting-information related to an acquisition of information. Based on the information acquired and information related to judgment criteria for regulating whether the communication is executed by a worm, the worm detection device 20a makes a judgment of whether the communication is executed by a worm.

The worm detection device 20a includes an interface 200, an input section 210, a display section 220, a storage unit 230, and a controller 240. The interface 200 is a network interface that forwards communication data between the network segment A 10a and the network 12 via the LAN 21 and the network 11.

The input section 210 is an input device such as a keyboard and a mouse. The display section 220 is a display device such as a CRT or an LCD monitor. The storage unit 230 is a storage device such as a hard disc device and stores setting-data 230a, communication-log data 230b, and worm data 230c.

The setting-data 230a includes various setting-information such as setting-information related to acquisition of the information related to the traffic and the communication address of the communication packet, and information related to the judgment criteria.

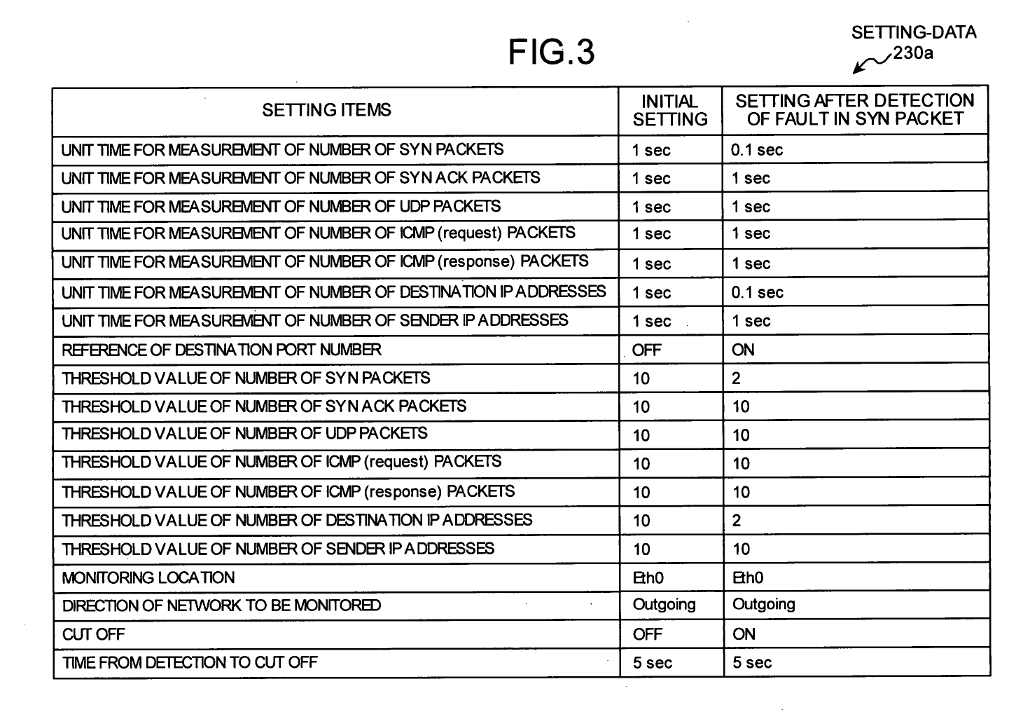

FIG. 3 is an example of contents of the setting-data 230a. The setting-data 230a includes setting items, initial setting, and setting after detection of fault in SYN packet. The setting items are items that are to be set in the setting-data 230a. The initial setting is setting information that is referred to during normal monitoring. The setting after detection of fault in SYN packet is setting information that is to be referred to instead of the initial setting when a fault is detected in an SYN packet that is being monitored. The fault in the SYN packet means that number of SYN packets measured during a unit time is greater than a corresponding predetermined threshold value and number of the destination IP addresses is greater than or equal to a corresponding predetermined threshold value.

Concretely, unit time for measurement of number of SYN packets, unit time for measurement of number of SYN ACK packets, unit time for measurement of number of UDP packets, unit time for measurement of number of ICMP (request) packets, unit time for measurement of number of ICMP (response) packets, unit time for measurement of number of destination IP addresses, unit time for measurement of number of sender IP addresses, reference of destination port number, threshold value of number of SYN packets, threshold value of number of SYN ACK packets, threshold value of number of UDP packets, threshold value of number of ICMP (request) packets, threshold value of number of ICMP (response) packets, threshold value of number of destination IP addresses, threshold value of number of sender IP addresses, monitoring location, direction of network to be monitored, cut off, and time from detection to cut off are registered as setting items.

The unit time for measurement of number of SYN packets is a unit time during which the number of SYN packets, which are TCP (Transmission Control Protocol) based packets, is measured. The unit time for measurement of number of SYN ACK packets is a unit time during which the number of SYN ACK packets that are transmitted as a response when the computer receives the SYN packets is measured. The unit time for measurement of number of UDP packets is a unit time during which the number of UDP packets, which are UDP (User Datagram Protocol) based packets, is measured. The unit time for measurement of number of ICMP request packets is a unit time during which the number of ICMP (Internet Control Message Protocol) packets that transmit operation-check message to a counterpart computer is measured. The unit time for measurement of number of ICMP (response) packets is a unit time during which the number of ICMP (response) packets that are transmitted as response to the ICMP (request) packets is measured. For example, the unit time of one second means that the number of packets sent or the number of packets received during one second is measured after every one second.

The unit time for measurement of number of destination IP addresses is a unit time during which the number of destination IP addresses for each packet is measured. The unit time for measurement of number of sender IP addresses is a unit time during which the number of sender IP addresses for each packet is measured. For example, the unit time of one second means that the number of destination addresses and the number of IP addresses of these packets during one second are measured after every one second. The reference of destination port number is an item to be set to indicate whether the destination port number for each packet is to be referred to in real time and is set to either ON or OFF.

The threshold value of number of SYN packets, the threshold value of number of SYN ACK packets, the threshold value of number of UDP packets, the threshold value of number of ICMP (request) packets, and the threshold value of number of ICMP (response) packets are information of threshold values of packets that are used while making a judgment of whether the communication is executed by a worm. The threshold value of number of destination IP addresses and the threshold value of number of sender IP addresses are information of threshold values of number of destination IP addresses and number of sender addresses while making a judgment of whether the communication is executed by a worm. In this case, the number of destination IP addresses or the number of sender IP addresses is number of different destination IP addresses or sender IP addresses that are measured during the unit time of measurement of number of destination IP addresses or the unit time of measurement of number of sender IP addresses.

The monitoring location is an item that sets a network driver which monitors the packets and the network driver is set such as ‘Eth0’. Direction of network to be monitored is an item that sets a direction of communication of a packet that is monitored. For example, when only that packet which is transmitted out from the network segment A 10a connected to the worm detection device 20a is monitored, the direction of network to be monitored is set as ‘outgoing’ and when a packet which is transmitted from the network 12 to the network segment A 10a is monitored, the direction of network to be monitored is set as ‘incoming’. When both packets are monitored, the direction of network to be monitored is set as ‘both’.

The cut off is an item that sets whether the communication is to be cut when the packet communication is judged to be executed by a worm. The cut off is set as either ‘ON’ or ‘OFF’. The time from detection to cut off is an item to set a waiting time till cutting the packet communication off when the packet communication executed by a worm is detected. The time from detection to cut off can be set as ‘5 sec’ for example.

Coming back to the description of FIG. 2, the communication-log data 230b includes a communication record of the packet communication. Concretely, the communication-log data 230b includes, for example, information of judgment of whether the communication is executed by a worm, the information of number of communication packets and number of IP addresses of communication packets that is acquired based on the setting-data 230a shown in FIG. 3.

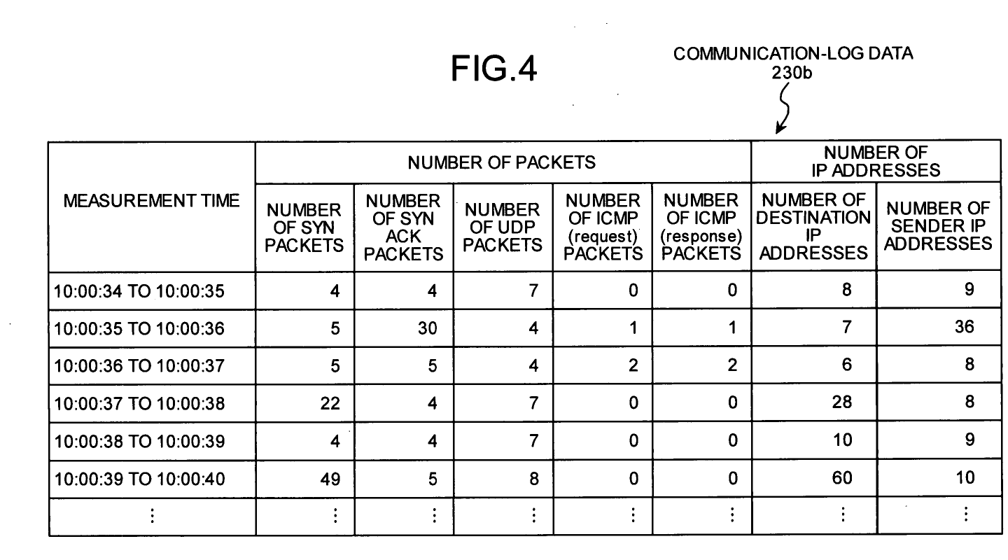

FIG. 4 is an example of contents of the communication-log data. The communication-log data 230b includes items of measurement time, number of packets, and number of IP addresses. The measurement time is time during which the measurement is done. The number of packets is measured during the measurement time. The number of packets further includes items of number of SYN packets, number of SYN ACK packets, number of UDP packets, number of ICMP (request) packets, and number of ICMP (response) packets. Each item included in the number of packets is measured according to the type of packet.

The number of IP addresses is number of IP addresses measured during each measurement time. The number of IP addresses further includes items of number of destination IP addresses and number of sender IP addresses. The number of destination IP addresses and the number of sender IP addresses include information of number of destination IP addresses and number of sender IP addresses of the communication packet during the corresponding measurement time.

When the item reference of destination port number in the setting-data 230a shown in FIG. 3 is ‘ON’, although not specifically shown in FIG. 4, information of most frequently targeted destination port number that is acquired by a communication-information acquisition section 240a (see FIG. 2) is stored in the communication-log data 230b according to each measurement time. Further, although not specifically shown in FIG. 4, when the communication is judged to be executed by a worm, the judgment result together with information of the worm that resembles to communication method of the worm, communication rate, and communication features is stored in the communication-log data 230b.

Coming back to the description of FIG. 2, the worm data 230c includes features of communication that is executed by a worm. Concretely, the worm data 230c includes information of features of a worm such as information of a scan speed of scan of other computer in a unit time by a worm that was identified in the past and a destination port number that is attacked by a worm.

The controller 240 controls the worm detection device 20a. The controller 240 includes the communication-information acquisition section 240a, a worm detection section 240b, a setting-data changing section 240c, and a communication cut off section 240d.

The communication-information acquisition section 240a acquires information related to traffic and a communication address of a communication packet based on the setting-data 230a stored in the storage unit 230. Concretely, the communication-information acquisition section 240a counts the number of communication packets and acquires the information of destination IP address and the sender IP address from a header of the communication packet. The communication-information acquisition section 240a also measures the number of destination IP addresses and the number of sender IP addresses, acquires information of the most frequently targeted destination port number from the information of the destination port number of the communication packet, and stores the information acquired into the communication-log data 230b.

The worm detection section 240b makes a judgment of whether the communication of a packet monitored is executed by a worm based on the information acquired by the communication-information acquisition section 240a and the setting-data 230a stored in the storage unit 230. How the worm detection section 240b makes the judgment is concretely described below in detail.

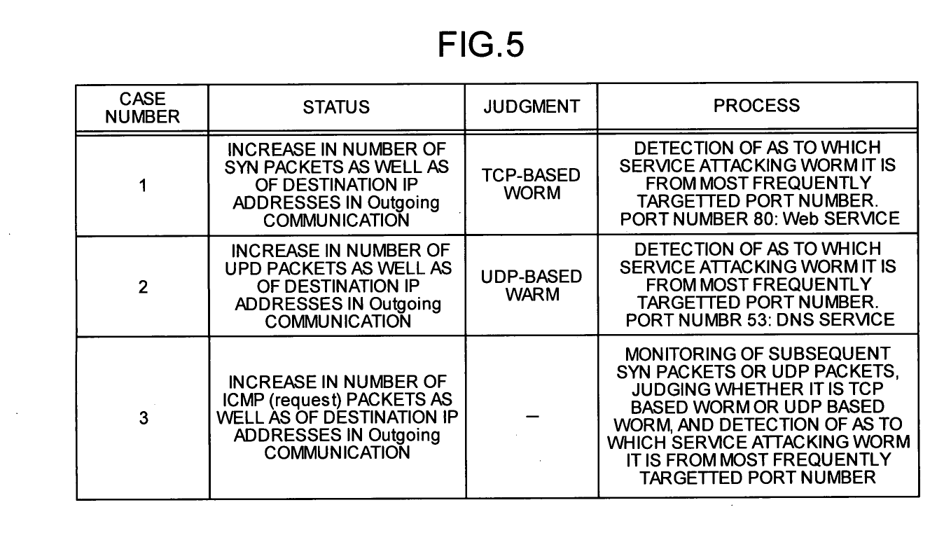

FIG. 5 is an example of a worm detection process performed by the worm detection section 240b according to the type of the packet. The detection process performed by the worm detection section 240b is divided into three cases. Case (case number) 1 indicates a status of an increase in number of SYN packets as well as of number of destination IP addresses when Outgoing communication is monitored.

Since this status indicates that a multiple number of SYN packets are transmitted to various computers other than those in the network segment A 10a, the worm detection section 240b makes a judgment that the computers in the network segment A 10a have been infected by a TCP-based worm and a random scan of the computers other than those in the network segment A 10a is being performed. In this case, the worm detection section 240b further checks the destination port number and detects as to which service attacking worm it is from the most frequently targeted destination port number. For example, if destination port number 80 is the most frequently targeted destination port number, the worm detection section 240b can make a judgment that the worm is a Web service attacking worm.

Case 2 indicates a status of an increase in number of UDP packets as well as of number of destination IP addresses when Outgoing communication is monitored. Since this status indicates that a multiple number of UDP packets are transmitted to various computers other than those in the network segment A 10a, the worm detection section 240b makes a judgment that the computers in the network segment A 10a have been infected by a UDP-based worm and the random scan of the computers other than those in the network segment A 10a is being performed. In this case, the worm detection section 240b further checks the destination port number and detects as to which service attacking worm it is from the most frequently targeted destination port number. For example, if destination port number 53 is the most frequently targeted destination port number, the worm detection section 240b can make a judgment that the worm is a DNS service attacking worm.

Case 3 indicates a status of an increase in number of ICMP (request) packets as well as of destination IP addresses when Outgoing communication is monitored. This status indicates that a multiple number of ICMP (request) packets are transmitted to various computers other than those in the network segment A 10a. In this case, the worm detection section 240b temporarily holds the judgment of whether the transmission of packets is executed by a worm. This is because the ICMP (request) packet is for transmitting operation-check message of the counterpart computer and just by the increase in the number of ICMP (request) packets and number of destination IP addresses, it is not clear whether the random scan by a worm is performed.

In this case, the worm detection section 240b monitors SYN packets or UDP packets which are transmitted afterwards and makes a judgment of whether it is a TCP based worm or a UDP based worm by judging the status as in the case 1 or the case 2. Further, the worm detection section 240b checks the destination port number and detects as to which service attacking worm it is from the most frequently targeted destination port number. Although the cases 1 to 3 are described above, by adding various statuses, a judgment can be made of whether the communication is executed by a worm according to the type of a packet.

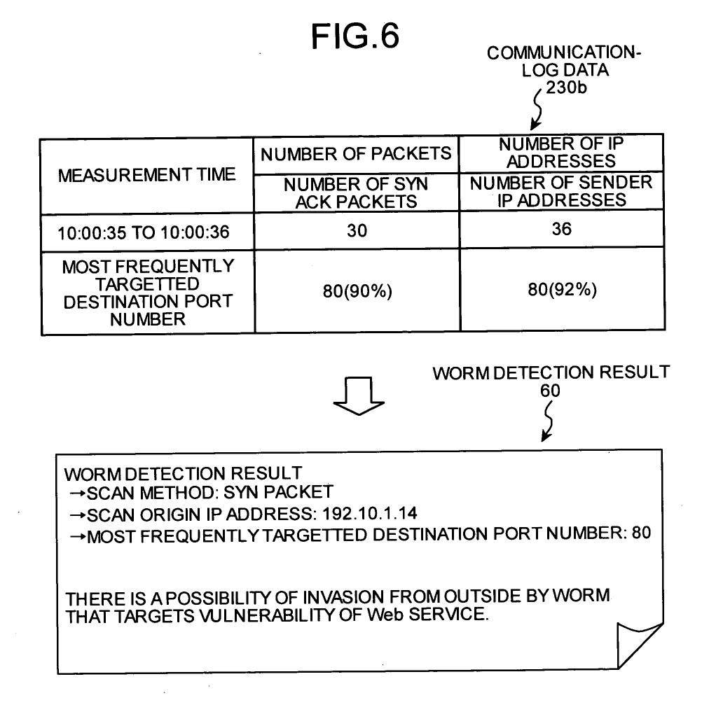

FIG. 6 is an example of a process performed by the worm detection section 240b of judging the presence of a worm scan from outside of the network segment. A case in which a fault is detected in the SYN ACK packet is indicated in FIG. 6. As shown in FIG. 6, the worm detection section 240b refers to the communication-log data 230b and checks if the number of packets and the number of IP addresses of each packet are not less than the corresponding threshold values stored in the setting-data 230a. For example, if the threshold value of the number of SYN ACK packets is 10 and if the threshold value of the number of sender IP addresses is 10, since the number of SYN ACK packets which is 30 during the measurement time 10:00:35 to 10:00:36 is not less than the threshold value 10 and the number of sender IP addresses which is 36 during the measurement time 10:00:35 to 10:00:36 is not less than the threshold value 10, the worm detection section 240b decides that the SYN ACK packet is faulty.

Moreover, the worm detection section 240b performs a process of detecting as to which service targeting worm it is from the information of the most frequently targeted destination port number of the SYN ACK packet that is acquired by the communication-information acquisition section 240a. The communication-log data 230b in FIG. 6 indicates information of a most frequently targeted destination port number 80 that is acquired. Information in percent (90% and 92%) in a column of the most frequently targeted destination port number is a percentage of packets which have the most frequently targeted port number 80 among the packets which are monitored for the number of SYN ACK packets and the number of sender IP addresses during the measurement time.

Further, the worm detection section 204b makes a judgment of the presence of a worm scan based on the information mentioned above and performs a process to output a worm detection result 60. Concretely, since the multiple number of SYN ACK packets which are responses upon receiving of the SYN packets, with the number of SYN ACK packets greater than the threshold value, are transmitted from inside of the network segment A 10a and since the number of sender IP addresses of the SYN ACK packets is greater than the threshold value, the worm detection section 240b makes a judgment that a random scan of the computers in the network segment A 10a from a computer in the network 12 is being executed by a worm and outputs the worm detection result 60 to that effect.

The worm detection result 60 includes information of scan method, scan origin IP address, the most frequently targeted destination port number, and warning message. The scan method indicates a type of packet that is used when the worm is performing the random scan. The scan origin IP address is an IP address of a computer that transmits a packet that is used for the random scam. Information of the scan origin IP address can be acquired from a packet header. The most frequently targeted destination port number is the number of the most frequently targeted destination port in the communication-log data 230b. The warning message is a message that informs the detection result to the user and draws user's attention. In the example in FIG. 6, since the random scan from the computer in the network 12 is detected, the user is informed of a possibility of invasion from outside by a worm that targets the vulnerability of the Web service.

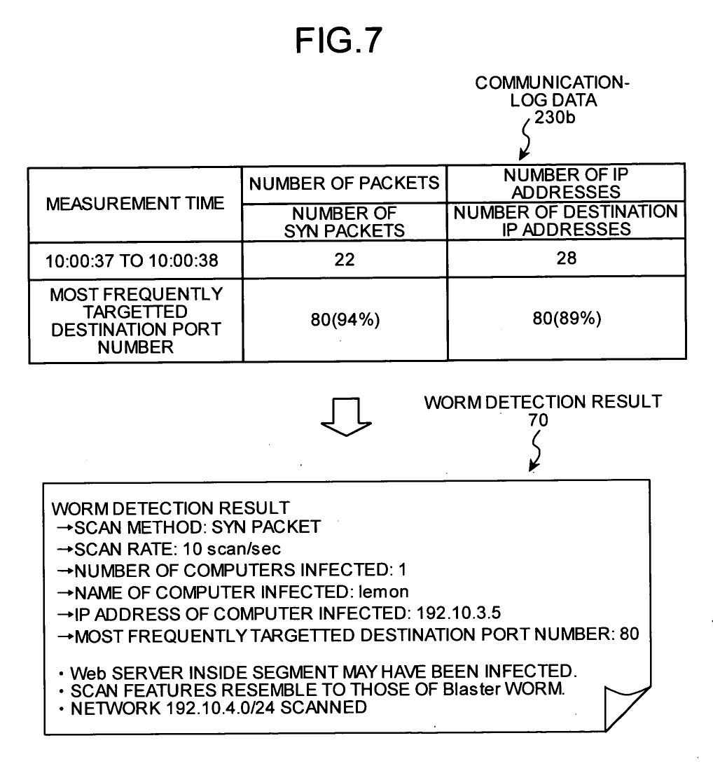

FIG. 7 is an example of a process performed by the worm detection section 240b of judging the presence of a worm infection. A case in which a fault is detected in the SYN packet is indicated in FIG. 7. As shown in FIG. 7, the worm detection section 240b refers to the communication-log data 230b and checks if the number of packets and the number of IP addresses of each packet are not less than the corresponding threshold values stored in the setting-data 230a. For example, if the threshold value of the SYN packet is 10 and if the threshold value of the number of destination IP addresses is 10, since the number of SYN packets which is 22 during the measurement time 10:00:37 to 10:00:38 is not less than the threshold value 10 and the number of destination IP addresses which is 28 during the measurement time 10:00:37 to 10:00:38 is not less than the threshold value 10, the worm detection section 240b decides that the SYN packet is faulty.

Moreover, the worm detection section 240b performs a process of detecting as to which service targeting worm it is from the information of the most frequently targeted destination port number of the SYN packet that is acquired by the communication-information acquisition section 240a. The communication-log data 230b in FIG. 7 indicates information of a most frequently targeted destination port number 80 that is acquired and information in percent of packets (94% and 89%) which have the most frequently targeted port number 80 among the packets which are monitored. The information of the most frequently targeted destination port number 80 and the information in percent of packets are indicated according to each measurement item, the number of SYN packets, and the number of destination IP addresses, respectively.

Further, the worm detection section 240b makes a judgment of the presence of a worm infection based on the information mentioned above and performs a process to output a worm detection result 70. Concretely, since the multiple number of SYN packets, with the number of SYN packets greater than the threshold value, are transmitted from inside of the network segment A 10a and since the number of destination IP addresses of the SYN packets is not smaller than the threshold value, the worm detection section 240b makes a judgment that a random scan of the computers in the network 12 from a computer in the network segment A 10a is being executed by a worm and outputs the worm detection result 70 to that effect.

The worm detection result 70 includes information of scan method, scan rate, number of computers infected, name of computer infected, IP address of computer infected, the most frequently targeted destination port number, and warning message. The scan method indicates a type of packet that is used when a worm performs the random scan. The scan rate indicates number of scans made per second. The number of computers infected indicates the number of computers that may have been infected by a worm. The name of computer infected indicates the name of a computer that may have been infected by a worm. The IP address of computer infected is an IP address of a computer that may have been infected by a worm.

The information about the scan rate can be calculated from number of computers (number of destination IP addresses) to which the SYN packets are transmitted per unit time. The IP address of the computer infected can be acquired from a header of the SYN packet. Information of the number of computers infected can be acquired from the number of IP addresses of the computer infected. The name of computer infected can be can be acquired by creating a database in which the name of computer infected associated with the IP address and the name of computer is stored. The most frequently targeted destination port number is the number of the most frequently targeted destination port in the communication-log data 230b. The warning message is a message that informs the detection result to the user and draws user's attention.

In the example mentioned in FIG. 7, since the random scan is detected inside the network segment A 10a and since the most frequently targeted destination port number is 20, the worm detection section 240b informs the user that the Web server inside the network segment A 10a may have been infected. Further, worm detection section 240b upon referring to features of a worm stored in the worm data 230c in the storage unit 230 informs the user about a worm that is judged to be resembling and about network that is subjected to the random scan.

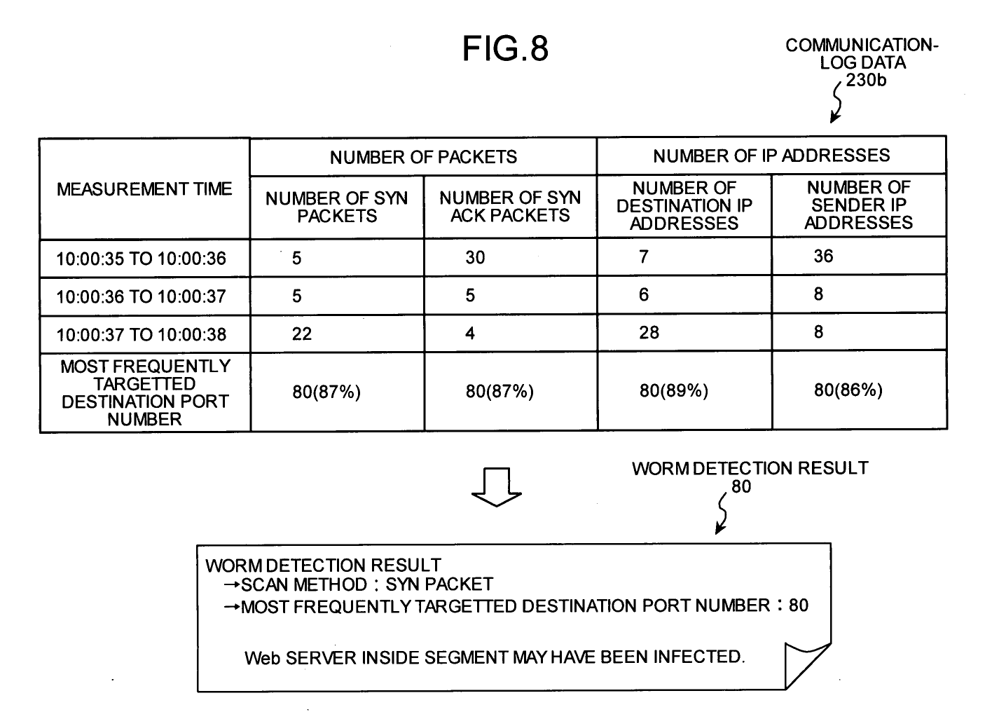

FIG. 8 is an example of a process performed by the worm detection section 240b of judging the presence of a worm infection by an attack from outside of the network segment A 10a. A case in which a fault is detected in the SYN packet after a fault is detected in the SYN ACK packet is indicated in FIG. 8. As shown in FIG. 8, the worm detection section 240b refers to the communication-log data 230b and checks if the number of packets and the number of IP addresses of each packet are not less than the corresponding threshold values stored in the setting-data 230a.

For example, if the threshold value of the SYN ACK packet is 10 and if the threshold value of the number of sender IP addresses is 10, since the number of SYN ACK packets which is 30 during the measurement time 10:00:35 to 10:00:36 is not less than 10 and the number of sender IP addresses which is 36 during the measurement time 10:00:35 to 10:00:36 is not less than the threshold value 10, the worm detection section 240b decides that the SYN ACK packet is faulty. Moreover, if the threshold value of the SYN packet is 10 and if the threshold value of the number of destination IP addresses is 10, since the number of SYN packets which is 22 during the measurement time 10:00:37 to 10:00:38 is not less than the threshold value 10 and the number of destination IP addresses which is 28 during the measurement time 10:00:37 to 10:00:38 is not less than the threshold value 10, the worm detection section 240b decides that the SYN packet is faulty.

Moreover, the worm detection section 240b performs a process of detecting as to which service targeting worm it is from the information of the most frequently targeted destination port number of the SYN ACK packet and the SYN packet that is acquired by the communication-information acquisition section 240a. The communication-log data 230b in FIG. 8 indicates information of the most frequently targeted destination port number 80 that is acquired, information in percent of packets (87%, 87%, 89%, and 86%) which have the most frequently targeted port number 80 among the packets which are monitored. The information of the most frequently targeted destination port number 80 and the information in percent of packets are indicated according to each measurement item, the number of SYN packets, the number of SYN ACK packets, the number of destination IP addresses, and the number of sender IP addresses, respectively.

Further, the worm detection section 240b makes a judgment of the presence of a worm infection based on the information mentioned above and performs a process to output a worm detection result 80. Concretely, since the multiple number of SYN ACK packets, with the number of SYN ACK packets greater than the threshold value, are transmitted from inside of the network segment A 10a and since the number of sender IP addresses of the SYN ACK packets is greater than the threshold value, the worm detection section 240b makes a judgment that a random scan of the computers in the network segment A 10a from a computer in the network 12 is being executed by a worm.

Further, since the multiple number of SYN packets, with the number of SYN packets greater than the threshold value, are transmitted from the inside of the network segment A 10a and since the number of destination addresses of the SYN packets is greater than the threshold value, the worm detection section 240b makes a judgment that a computer in the network segment A 10a has been infected by a worm and a random scan of a computer in the network 12 is being performed by the computer that has been infected by the worm. The worm detection section 240b outputs the worm detection result 80.

The worm detection result 80 includes information of scan method, the most frequently targeted destination port number, and warning message. The scan method indicates a type of packet that is used when a worm performs the random scan. The most frequently targeted destination port number is the number of the most frequently targeted port in the communication-log data 230b. The warning message is a message that informs the user about a possibility of infection of the Web server in the network segment A 10a by a worm attack from outside.

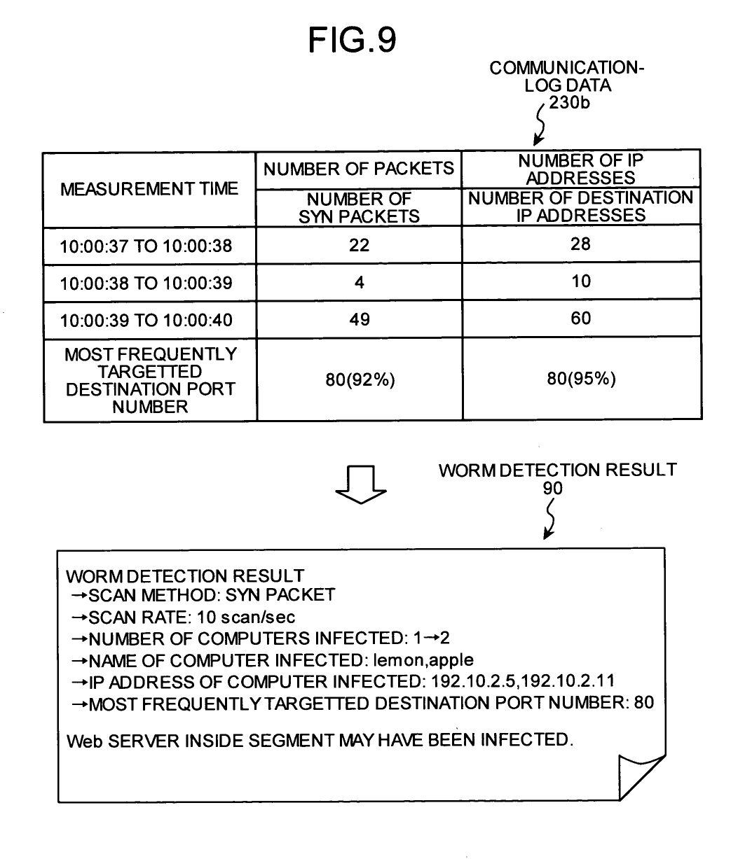

FIG. 9 is an example of a process performed by the worm detection device shown in FIG. 2 of judging the presence of a worm infection in a plurality of computers. A case in which, when a fault is detected in the SYN packet once again after a fault is detected in the SYN packet, the number of destination IP addresses when the fault is detected repeatedly in the SYN packet increases and becomes more than the number of IP addresses when the fault is detected previously in the SYN packet is indicated in FIG. 9.

As shown in FIG. 9, the worm detection section 240b refers to the communication-log data 230b and checks if the number of packets and the number of IP addresses of each packet are not less than the corresponding threshold values stored in the setting-data 230a. For example, if the threshold value of the number of SYN packets is 10 and the threshold value of the number of sender IP addresses is 10, since the number of SYN packets which is 22 during the measurement time 10:00:37 to 10:00:38 is not less than the threshold value 10 and the number of sender IP addresses which is 28 during the measurement time 10:00:37 to 10:00:38 is not less than the threshold value 10, the worm detection section 240b decides that the SYN packet is faulty. Moreover, since the number of SYN packets which is 49 during the measurement time 10:00:39 to 10:00:40 is not less than the threshold value 10 and the number of destination IP addresses which is 60 during the measurement time 10:00:39 to 10:00:40 is not less than the threshold value 10, the worm detection section 240b decides that the SYN packet is faulty.

Moreover, the worm detection section 240 performs a process of detecting as to which service targeting worm it is from the information of the most frequently targeted destination port number of the SYN packet that is acquired by the communication-information acquisition section 240a. The communication-log data 230b in FIG. 9 indicates information of a most frequently targeted destination port number 80 that is acquired and information in percent of packets (92% and 95%) which have the most frequently targeted port number 80 among the packets which are monitored. The information of the most frequently targeted destination port number 80 and the information in percent of packets are indicated according to each measurement item, the number of SYN packets, and the number of destination IP addresses, respectively.

Further, the worm detection section 240b makes a judgment of the presence of a worm infection based on the information mentioned above and outputs a worm detection result 90. Concretely, since the number of SYN packets, with the number of SYN packets greater than the threshold value 10, are transmitted from the network segment A 10a and since the number of destination IP addresses of the SYN packets is not smaller than the threshold value 10, the worm detection section 240b makes a judgment that a computer in the network segment A 10a has been infected and a random scan of a computer in the network 12 is being executed from the computer that has been infected by a worm.

Moreover, since the most frequently targeted port number is 80 and the number of destination IP addresses when the fault is detected in the SYN packet repeatedly has increased to be more than double the number of destination IP addresses when the fault was detected in the SYN packet previously, the worm detection section 240b makes a judgment that a plurality of computers in the network segment 10a have been infected by a worm and outputs the worm detection result 90 to that effect. When the number of IP addresses increased to more than double, a judgment is made that many Web servers have been infected. However, the dependence of the judgment of the Web servers being infected on by how many times the number of IP addresses increase, can be set as desired.

The worm detection result 90 includes information of scan method, scan rate, number of computers infected, names of computers infected, IP addresses of computers infected, the most frequently targeted destination port number, and warning message. The scan method indicates a type of packet that is used when a worm performs the random scan. The scan rate indicates number of scans made per second. The number of computers infected indicates the number of computers which have been infected by a worm. The names of computers infected indicate the names of computers which may have been infected by a worm. The IP addresses of computers infected are IP addresses of computers which may have been infected by a worm. In the example in FIG. 9, IP addresses and computer names of two Web servers are indicated.

The most frequently targeted destination port number is the number of the most frequently targeted destination port in the communication-log data 230b. The warning message is a message that informs the detection result to the user and draws user's attention. In the example in FIG. 9, the worm detection result 90 informs the user by the warning message that the plurality of Web servers in the network segment A 10a may have been infected by a worm.

Coming back to the description of FIG. 2, when there is a change in the setting-data 230a, the setting-data changing section 240c receives new settings which are input by the user and adds new setting items or makes changes in the setting items. In addition, the setting-data changing section 240c deletes setting items that are already set and makes changes in the setting-data 230a. Moreover, when a fault is detected in the SYN packet that is being monitored, the setting-data changing section 240c performs a process of changing the setting in the setting-data 230a from initial setting to settings after the detection of the fault in the SYN packet.

When the packet communication is judged to be executed by a worm, the communication cut off section 240d cuts off the packet communication. A process of cutting off is performed when the setting item CUT OFF in the setting-data 230a is ON (see FIG. 3). Moreover, the communication cut off section 240d refers to the setting item time from detection to cut off in the setting-data 230a in FIG. 3, and starts the process of cut off after waiting for time that is set as the time from detection to cut off.

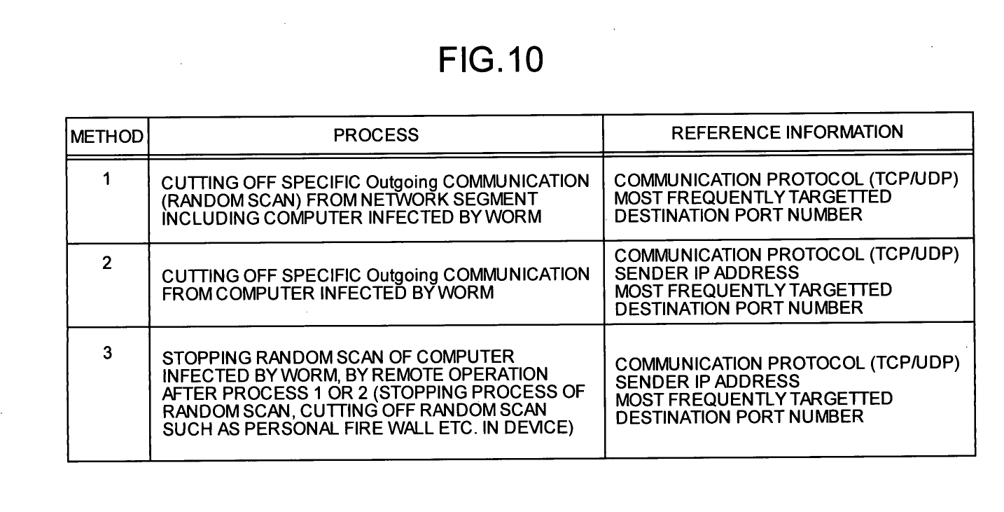

Concretely, the communication cut off section 240d cuts off the packet communication executed by a worm by three methods. FIG. 10 is an example of the process performed by the communication cut off section 240d of cutting off the communication executed by a worm. As shown in FIG. 10, in a method 1, the communication cut off section 240d cuts off specific Outgoing communication (random scan) from all the computers in the network segment A 10a including the computer that is infected by a worm. In the method 1, the Outgoing communication is cut off after referring to information such as whether a protocol of the communication packet that is transmitted by a worm is a TCP-based protocol or a UDP-based protocol and the most frequently targeted destination port number. When cutting off the communication, the communication cut off section 240d does not cut off communication packets other than those which are specified by this information, thereby minimizing communication failure.

In a method 2, the communication cut off section 240d cuts off specific Outgoing communication from the computer in the network segment A 10 that is infected by a worm. In the method 2, the Outgoing communication is cut off after referring to information such as whether the protocol of the communication packet that is transmitted by a worm is a TCP-based protocol or a UDP-based protocol, a sender IP address that specifies the computer that is infected by a worm, and the most frequently targeted destination port number of the communication packet. When cutting off the communication, the communication cut off section 240d does not cut off communication packets other than the communication packets which are specified by this information, thereby minimizing communication failure.

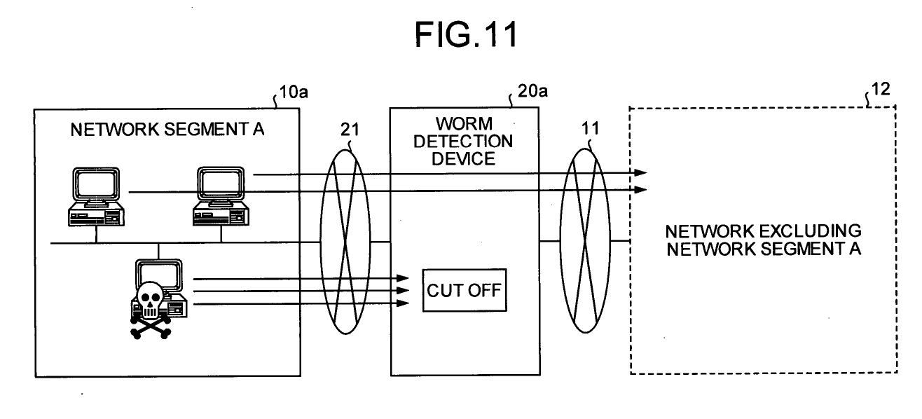

FIG. 11 is to explain how the worm detection device 20a cuts off the communication executed by a worm. In FIG. 11, the cutting off of the Outgoing communication according to the methods 1 or 2 is illustrated. As shown in FIG. 11, the communication cut off section 240d cuts off the Outgoing communication executed by a worm from the network segment A 10a that is monitored by the worm detection device 20a and prevents the communication packets which are transmitted by a worm from reaching the network 12. The communication cut off section 240d allows communication packets which are not transmitted by the worm to pass through the worm detection device 20a, thereby avoiding communication failure.

Coming back to the description of FIG. 10, in a method 3, after the process of cutting off by the methods 1 or 2, the communication cut off section 240d stops random scan of the computer infected by a worm, by a remote operation. Concretely, the communication cut off section 240d makes an access to the computer infected by a worm and stops a process that is performing the random scan. The communication cut off section 240d sets functions such as personal fire wall of the computer infected by a worm, to active mode and makes the computer infected by a worm, cut off the random scan performed by the computer that is judged to be infected by a worm. In the method 3, the random scan is cut off by the remote operation after referring to information such as whether the protocol of the communication packet that is transmitted by a worm is a TCP-based protocol or a UDP-based protocol, a sender IP address that specifies the computer that is infected by a worm, and the most frequently targeted destination port number of the communication packet. When cutting off the communication, the communication cut off section 240d operates such that the computer infected by a worm does not cut communication packets other than those which are specified by this information, thereby minimizing the communication failure.

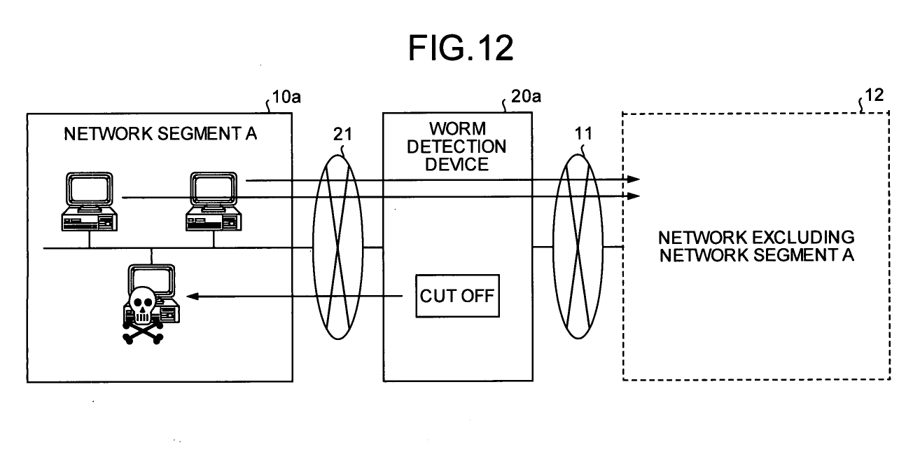

FIG. 12 is how the computer that is infected cuts off the communication executed by a worm. FIG. 12 indicates the cutting off by the random scan according to the method 3. As shown in FIG. 12, the communication cut off section 240d makes the computer infected by a worm cut off the random scan and prevents the communication packets which are transmitted by the worm from reaching the network 12. The communication cut off section 240d operates the computer infected by a worm such that the computer does not cut off communication packets which are not transmitted by the worm, thereby avoiding the communication failure. In this case, the cutting off process according to the method 3 is performed after the cutting off according to the methods 1 or 2. However, the cutting of process according to the method 3 may also be performed independently.

The acquisition of communication information mentioned in claims is executed by, for example, the communication-information acquisition section 240a. The detection of a worm mentioned in the claims is performed by, for example, the worm detection section 240b. The changing of the setting information mentioned in the claims is performed, for example, by the setting-data changing section 240c. The cut off of a communication mentioned in the claims is performed by, for example, the communication cut off section 240d.

Moreover, setting information mentioned in the claims is, for example, information of the items such as the unit time for measurement of number of SYN packets, the unit time for measurement of number of SYN ACK packets, the unit time for measurement of number of UDP packets, the unit time for measurement of number of ICMP (request) packets, the unit time for measurement of ICMP (response) packets, the unit time for measurement of number of destination IP addresses, the unit time for measurement of sender IP addresses, the reference of destination port number, the monitoring location, and the direction of network to be monitored. Judgment criteria are, for example, the threshold value of number of SYN packets, the threshold value of number of SYN ACK packets, the threshold value of number of UDP packets, the threshold value of number of ICMP (request) packets, the threshold value of number of ICMP (response) packets, the threshold value of number of destination IP addresses, and the threshold value of number of sender IP addresses.

Further, information related to computer mentioned in the claims is, for example, the scan origin IP address, the number of computers infected, the name of computer infected, and the IP address of computer infected in the worm detection results 60, 70 or 90 shown in FIGS. 6, 7, or 9 respectively. Information related to communication status mentioned in the claims is, for example, the scan method, the most frequently targeted destination port number, the warning message, and the scan rate. The log mentioned in the claims is, for example, the communication-log data 230b.

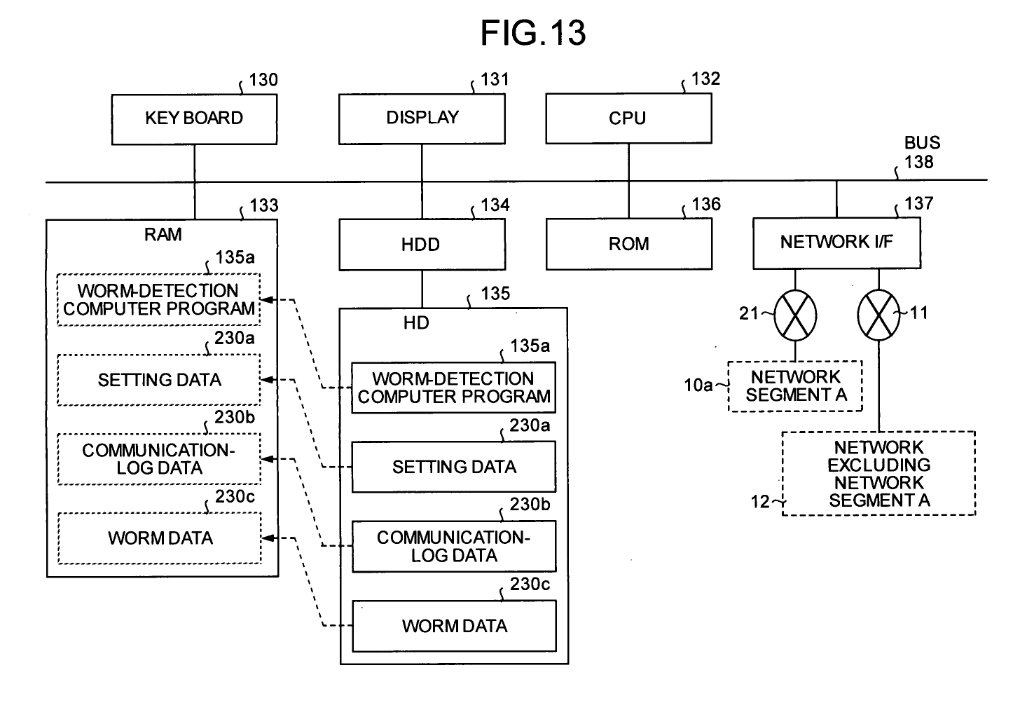

A hardware configuration of the worm detection device 20a according to the embodiment is described below. FIG. 13 is a block diagram of the hardware configuration of the worm detection device 20a. As shown in FIG. 13, the worm detection section 20a includes a key board 130, a display 131, a central processing unit (CPU) 132, a random access memory (RAM) 133, a hard disc drive (HDD) 134, a read-only memory (ROM) 136, and a network interface (I/F) 137 which are connected by a bus 138.

The network I/F 137 perform communication between the worm detection unit 20a and the network 12 or the network segment A, via the LAN 21 or the network 11.

The HDD 134 reads a hard disc (HD) 135 that is installed in the HDD 134 as a recording medium. A worm-detection computer program 135a that makes a computer execute a method of worm detection according to the embodiment is stored in the HD 135. The worm detection process is executed by interpreting by the CPU 132 after it is read by the RAM 133.

A worm detection process corresponds to functions of sections in the controller 240 shown in FIG. 2 such as the communication-information acquisition section 240a, the worm detection section 240b, the setting-data changing section 240c, and the communication cut off section 240d. Further, the setting-data 230a, the communication-log data 230b, and the worm data 230c are also stored in the HD 135, read by the RAM 133, and referred to by the CPU 132.

The computer program for worm detection 135a can be distributed via a network such as the Internet. The computer program for worm detection 135a can also be stored in a computer readable recording medium such as a hard disc, a flexible disc (FD), a CD-ROM, an MO, and a DVD and can be executed by reading from the recording medium by the computer.

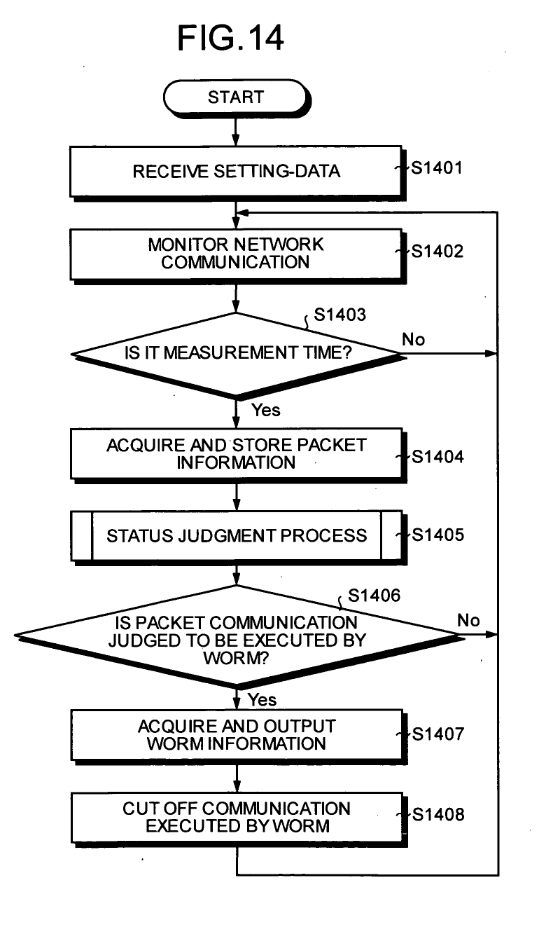

The worm detection process according to the embodiment is described below. FIG. 14 is a flow chart of the worm detection process according to the embodiment. As shown in FIG. 14, to start with, if there is a change in the setting-data 230a, the setting-data changing section 240c of the worm detection device 20a receives settings that are input by the user (step S1401).

Next, the communication-information acquisition section 240a monitors communication between the computers in the network segment A 10a and the computers in the network 12 (step S1402), and checks if it is a time for measurement of packets based on the unit time for measurement set in the setting-data 230a (step S1403).

If it is not the time for the measurement of packets (“No” at step S1403), the process control is returned to step S1402. If it is the time for the measurement of packets (“Yes” at step S1403), the communication-information acquisition section 240a acquires packet information and stores the information acquired in the communication-log data 230b (step S1404).

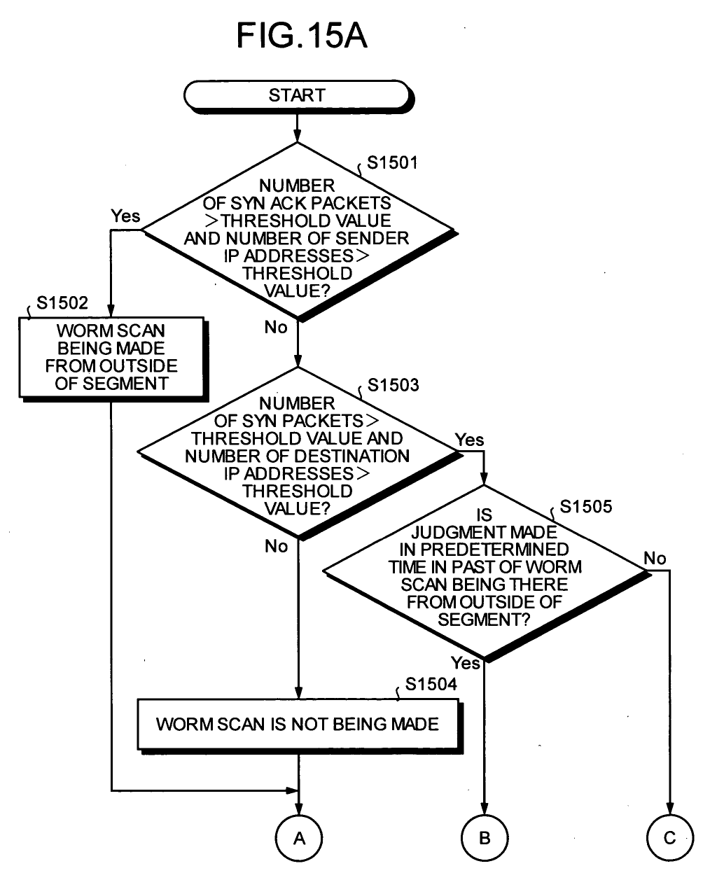

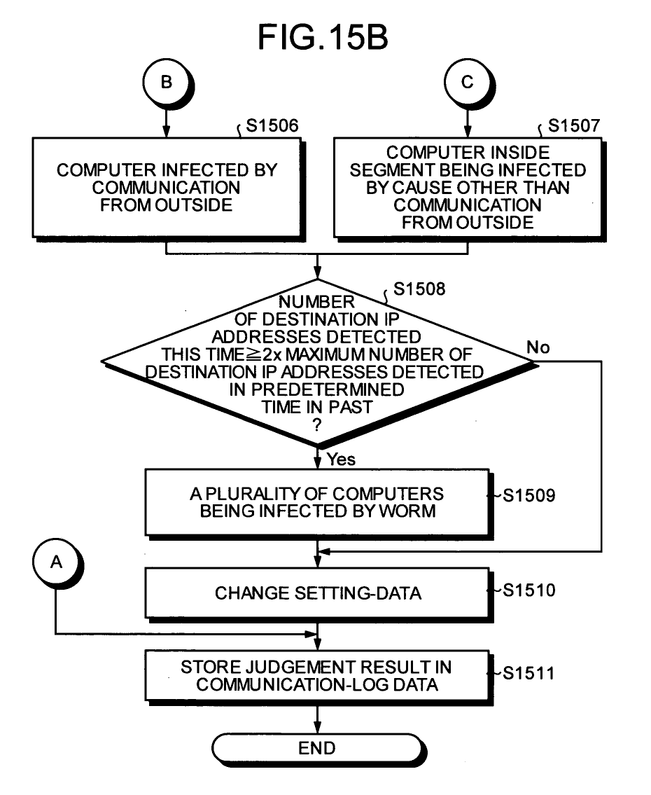

Further, based on the information acquired by the communication-information acquisition section 240a and the information stored in the communication-log data 230b, the worm detection section 240b makes a status judgment of whether a packet communication is executed by a worm (step S1405). This status judgment process is described in detail in the latter part by referring to FIGS. 15A and 15B.

If the worm detection section 240b makes a judgment that the packet communication is not executed by a worm (“No” at step S1406), the process control is returned to step S1402. If the packet communication is judged to be executed by a worm (“Yes” at step S1406), the worm detection section 240b acquires information of worm having resembling (similar) scan method, scan rate, and scan features and outputs this information (step S1407).

The communication cut off section 240d cuts off the packet communication that is judged to be executed by a worm by methods explained with reference to FIGS. 10 to 12 (step S1408) and ends the worm detection process.

The status judgment process is described below in detail. FIGS. 15A and 15B are flow charts of the status judgment process. As shown in FIG. 15A, to start with, the worm detection section 240b checks if number of SYN ACK packets acquired by the communication-information acquisition section 240a is greater than a threshold value of number of SYN ACK packets that is set in the setting-data 230 and if number of sender IP addresses is greater than a threshold value of number of sender IP addresses set in the setting-data 230a (step S1501).

If the number of SYN ACK packets is greater than the threshold value of the number of SYN ACK packets and if the number of sender IP addresses is greater than the threshold value of the number of sender IP addresses (“Yes” at step S1501), the worm detection section 240b makes a judgment that a worm scan is being made from outside of the network segment A 10a (step S1502), stores a judgment result in the communication-log data 230b (step S1511) (see FIG. 15B), and ends the status judgment process.

At step S1501, if any one of the two conditions is not satisfied (“No” at step S1501), the worm detection section 240b checks if the number of SYN packets acquired by the communication-information acquisition section 240a is greater than the threshold value of the number of SYN packets that is set in the setting-data 230 and if the number of destination IP addresses is greater than the threshold value of the number of destination IP addresses set in the setting-data (step S1503).

If any one of the two conditions is not satisfied (“No” at step S1503), the worm detection section 240b makes a judgment that a worm scan not being made (step S1504), stores a judgment result in the communication-log data 230b (see FIG. 15B), and ends the status judgment process.

If the number of SYN packets is greater than the threshold value of the number of SYN packets and if the number of destination IP addresses is greater than the threshold value of the destination IP addresses (“Yes” at step S1503), the worm detection section 240b checks if a judgment was made in a predetermined time in the past of the worm scan being made from the outside of the network segment A 10a (step S1505). The predetermined time in the past means for example, time from five minutes before to the current time.

If the judgment of the worm scan being made from the outside of the network segment A 10a was made in a predetermined time in the past (“Yes” at step S1505), the worm detection section 240b makes a judgment that the computer in the network segment A 10a has been infected by a worm from a packet communication from the outside of the network segment A 10a (step S1506).

If the judgment of the worm scan being made from the outside of the network segment A 10a was not made in a predetermined time in the past (“No” at step S1505), the worm detection section 240b makes a judgment that the computer in the network segment A 10a has been infected by a worm due to a cause other than the packet communication from the network segment A 10a (step S1507) (see FIG. 15B). An example of the cause other than the packet communication from the network segment A 10a is such as a computer in the network segment A 10a getting infected by a worm from a recording medium such as a flexible disc (FD) or a CD-ROM.

After making the judgments at step S1506 and step S1507, the worm detection section 240b checks if number of destination IP addresses detected at this time is not less than double the maximum number of destination IP addresses that were detected in predetermined time in the past (step S1508). If the number of destination IP addresses detected this time is not less than double the maximum number of destination IP addresses which were detected in the predetermined time in the past (“Yes” at step S1508), the worm detection section 240b makes a judgment that a plurality of computers in the network segment have been infected by the worm (step S1509) and the setting-data changing section 240c changes the settings in the setting-data 230a that is referred to by the communication-information acquisition section 240a, the worm detection section 240b, or the communication cut off section 240d from initial settings to settings after a fault in the SYN packets is detected (step S1510).

At step S1508, if the number of destination IP addresses detected at that time is less than double the maximum number of destination IP addresses which were detected in the predetermined time in the past (“No” at step S1508), the process control is shifted to step S1510 and the setting-data changing section 240c changes the settings in the setting-data 230a from the initial settings to settings after a fault in the SYN packets is detected. Further, the worm detection section 240b stores a judgment result in the communication-log data 230b and ends the status judgment process.

Thus, according to the present embodiment, the communication-information acquisition section 240a acquires information related to communication address and traffic of the communication packets based on setting information related to acquisition of information stored in the setting-data 230a. The worm detection section 240b makes a judgment of whether the communication is executed by a worm based on information acquired by the communication-information acquisition section 240a and information related to judgment criteria stored in the setting-data 230 that regulates whether the communication is executed by a worm. Therefore, irrespective of whether it is a server or a client device, the judgment of whether the communication is executed by a worm can be made easily and efficiently.

If the communication is judged to be executed by a worm, the setting-data changing section 240c changes setting information related to acquisition of information stored in the setting-data 230a. The communication-information acquisition section 240a acquires information related to the communication address and traffic of the communication packet based on the setting information related to acquisition of information that is changed. Therefore, by changing the setting information related to the acquisition of the information when the communication is judged to be executed by a worm, it is possible to monitor the behavior of a worm in more detail.

The setting-data changing section 240c adds information that is to be set newly to the setting information related to the acquisition of the information stored in the setting-data 230a. The setting-data changing section 240c deletes information that is set in the setting information related to the acquisition of the information. Therefore, by appropriately updating the setting information related to the acquisition of the information, it is possible to monitor the behavior of a worm in more detail.

When the communication is judged to be executed by a worm, the setting-data changing section 240c changes information related to judgment criteria stored in the setting-data 230a and the judgment of whether the communication is executed by a worm is made based on information that is acquired by the communication-information acquisition section 240a and information related to judgment criteria that is changed. Therefore, when the communication is judged to be executed by a worm, by changing the information related to the judgment criteria, it is possible to make a precise judgment of the communication be executed by a worm.

The setting-data changing section 240c adds information to perform new settings related to the judgment criteria that is stored in the setting-data 230a. The setting-data changing section 240c deletes information that is set to information related to the judgment criteria. Therefore, by appropriately updating the information related to the judgment criteria, it is possible to make a precise judgment of the communication by a worm.

When there is an increase in the number of packets as well as the number of destination addresses of communication packets which are transmitted from the network segment A 10a that is monitored for communication to the network 12 excluding the network segment A, the worm detection section 240b makes a judgment that the communication from a computer in the network segment A 10a is executed by a worm. Therefore, the judgment of whether a communication is executed by a worm can be made easily and efficiently.

When a communication from a computer inside the network segment A 10a that is subjected to monitoring is judged previously to be executed by a worm and when the number of destination addresses of a communication packet that is transmitted from the network segment A 10a to the network 12 excluding the network segment A becomes greater than the number of destination addresses of a communication packet that are acquired by the communication-information acquisition section 240a, which is transmitted from the network segment A 10a to the network 12 excluding the network segment A, the worm detection section 240b makes a judgment that the communication from the computer in the network segment A 10a is being executed by a worm that has infected a plurality of computers. Therefore, when a communication executed by a worm is performed by a plurality of computers in the predetermined network segment A 10a, the judgment can be made easily and effectively.

When there is an increase in number of response communication packets corresponding to communication packets that are transmitted from the network 12 excluding the network segment A to the network segment A 10a and subjected to monitoring, as well as when there is an increase in the number of sender addresses of the communication packet, the worm detection section 240b makes a judgment that a communication from a computer outside the network segment A 10a has been executed by a worm. Therefore, when a communication executed by a worm is performed by a computer outside the predetermined network segment A 10a, the communication can be judged easily and efficiently.

When a communication is judged to be executed by a worm, the worm detection section 240b outputs information about a computer that performed the communication. Therefore it possible to specify a computer that might have been infected by a worm based on the information about the computer that is output.

When a communication is judged to be executed by a worm, the worm detection section outputs information about a communication status. Therefore, it is possible to know about a status of activity of a worm based on the information status that is output.

When a communication is judged to be executed by a worm, the worm detection section 240b stores a judgment result as communication-log data 230. Therefore, status of a communication executed by a worm in the past can be checked any time.

When a communication is judged to be executed by a worm, the worm detection section 240b can predict a type of the worm by comparing features of the communication judged to be executed by a worm with features of communications judged to be executed by a worm which are stored in the worm data 230c. Therefore, an attack by a worm can be dealt with properly, based on information of the type of a worm detected.

When a communication is judged to be executed by a worm, the communication cut off section 240d cuts the communication off. Therefore, reproduction of worm can be controlled effectively.

The communication cut off section 240d cuts a communication executed by a worm by stopping a process that is started by a worm. Therefore, reproduction of a worm can be controlled effectively by stopping the process that was executed by a worm.

The communication cut off section 240d cuts of a communication executed by a worm by making a fire wall function effective in a computer that is judged to have a worm. Therefore by making the computer that is infected by a worm cut off the communication executed by a worm, reproduction of a worm can be controlled effectively.

The embodiments of the present invention have been described so far. The present invention can also be applied with various different embodiments within the scope of technical teachings mentioned in the claims.

For example, in the present embodiment the worm detection device 20a is connected to the network segment A 10a via the LAN 21. However, the present embodiment is not limited to this and the worm detection device 20a may be connected directly to a computer in the network segment A 10a. When only one computer is included in the network segment A 10a, a computer program for worm detection may be introduced in the computer and make the computer monitor a communication related to the network segment A 10a and perform a worm detection process.

According to the present embodiment, mainly SYN packets and SYN ACK packets are mentioned as communication packets to be monitored. However, the present invention is not limited to the SYN packets and the SYN ACK packets only and is also applicable to UDP packets, ICMP packets or packets following the other protocols.

According to the present embodiment, a judgment of whether a communication is executed by a worm is made based on a method of detection shown in FIGS. 5 to 9. However, the present invention is not limited to the methods described and other methods of worm detection which use information related to traffic and communication address of communication packets can also be used.

Among processes described in the present embodiment, some or all processes that are performed automatically can be performed manually and some or all processes that are performed manually can be performed automatically by known methods. Information including processing procedures, control procedure, concrete names, various data and parameters described so far or shown in diagrams can be changed voluntarily except when mentioned specifically.

Only outline of functions of components of devices and units shown in the diagrams is described so far and the components need not be arranged or structured physically as shown in the diagram. For example, a concrete form of separated or integrated worm detection devices 20a to 20d is not limited to that shown in the diagram. The worm detection devices 20a to 20d, wholly or partly, can be arranged or structured voluntarily by separating or integrating physically or functionally according to load and use of each of the devices. Moreover, processing function performed by each of the worm detection devices 20a to 20d, wholly or partly, can be realized by a CPU or a computer program that is interpreted and executed by the CPU or can be realized as hardware by a wired logic.

According to the present invention, information related to traffic and communication address of a communication packet is acquired based on setting-information related to acquisition of information. Further, a judgment of whether communication is executed by a worm is made based on information related to judgment criteria that regulate whether the communication is executed by a worm and the information acquired. Therefore, irrespective of whether it is a server or a client device, it is possible to make a judgment easily and efficiently, of whether the communication is executed by a worm.

Further, when the communication is judged to be executed by a worm, setting-information related to the acquisition of the information is changed. The information related to the traffic and the communication address of the communication packet is acquired based on the setting-information related to the acquisition of the information that is changed. Therefore, by changing the setting-information related to the acquisition of the information when the communication is judged to be executed by a worm, it is possible to monitor the behavior of a worm in more detail.

Further, when the communication is judged to be executed by a worm, the information related to the judgment criteria is changed and the communication is judged to be executed by a worm based on the information related to the judgment criteria and the information acquired. Therefore, when the communication is judged to be executed by a worm, by changing the information related to the judgment criteria, it is possible to make a precise judgment of the communication be executed by a worm.

Further, when there is an increase in number of packets as well as an increase in number of destination addresses of communication packets which are transmitted from a predetermined network segment that is subjected to monitoring of communication, to an outside of the predetermined network segment, a judgment of whether the communication from a computer inside the predetermined network segment is executed by a worm is made. Therefore, when the communication executed by a worm is performed from the computer inside the predetermined network segment, the judgment of the communication can be made easily and efficiently.

Further, when a communication from a computer inside the predetermined network segment that is subjected to monitoring of the communication is judged previously, to be executed by a worm and when number of destination addresses of a communication packet that is transmitted out from the predetermined network segment becomes greater than number of destination addresses of a communication packet which are acquired while making the judgment of the communication be executed by a worm, that is transmitted out from the predetermined network segment, the communication from the computer in the predetermined network segment is judged to be executed by a worm that has infected a plurality of computers. Therefore, when a communication executed by a worm is performed from the plurality of computers in the network segments, the judgment can be made easily and efficiently.

Further, when there is an increase in number of response communication packets corresponding to communication packets that are transmitted from an outside of the predetermined network segments to the predetermined network segment that is subjected to monitoring of the communication as well as when there is an increase in number of sender addresses of the communication packet, a communication from a computer outside the predetermined network segment is judged to be executed by a worm. Therefore, when a communication executed by a worm is performed by the computer outside the predetermined network segment, the communication can be judged easily and efficiently.

Further, when a communication is judged to be executed by a worm, information about a computer that performs the communication or information about a communication status is output. Therefore, it is possible to specify a computer that might have been infected by a worm, based on the information output about the computer.

Further, when a communication is judged to be executed by a worm, a type of a worm can be predicted by comparing features of the communication judged to be executed by a worm with features of communications judged to be executed by a worm that are registered in advance. Therefore, an attack by a worm can be dealt with appropriately based on information of the type of a worm predicted.

Further, when a communication is judged to be executed by a worm, the communication is cut off. Therefore, reproduction of a worm can be controlled effectively.

Further, a communication executed by a worm is cut off by stopping a process that was started by a worm. Therefore, reproduction of a worm can be controlled effectively by stopping the process that was executed by a worm.

Further, a communication executed by a worm is cut off by making a fire wall function effective in a computer that is judged to have a worm. Therefore, by making the computer that is infected by a worm cut off the communication executed by a worm, reproduction of a worm can be controlled effectively.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A computer program for detecting a worm by monitoring a communication of a predetermined network segment that is connected to a network and judging whether the communication is executed by a worm, causes a computer to perform:
acquiring information related to a traffic and a communication address of a communication packet based on setting information; and
judging whether the communication is executed by the worm based on the information acquired and a predetermined judgment criteria.

2. The computer program according to claim 1, causes the computer to further perform changing the setting information upon it is judged at the judging that the communication is executed by the worm, wherein
the acquiring includes acquiring the information based on the setting information after change.

3. The computer program according to claim 1, causes the computer to further perform changing the judgment criteria upon it is judged at the judging that the communication is executed by the worm, wherein
the judging includes judging whether the communication is executed by the worm based on the information acquired and the setting information after change.

4. The computer program according to claim 1, wherein the judging includes judging that a communication from a computer that is in the predetermined network segment is executed by the worm when
there is an increase in number of communication packets as well as number of destination addresses of communication packets that are transmitted from the predetermined network segment to the outside.

5. The computer program according to claim 4, wherein the judging includes judging that a communication from a plurality of computer in the predetermined segment is executed by the worm when
a communication from a computer in the predetermined network segment is judged previously to be executed by the worm, and
the number of destination addresses of the communication packet that is transmitted from the predetermined network segment to the outside becomes greater than a number of destination addresses of a communication packet acquired when the communication is judged to be executed by the worm, and is transmitted from the predetermined network segment to the outside.

6. The computer program according claim 1, wherein the judging includes judging that a communication from a computer that is outside the predetermined network segment is executed by the worm when
there is an increase in number of responding communication packets corresponding to communication packets that are transmitted from outside to the predetermined network segment, and
there is an increase in number of sender addresses of the communication packets.

7. The computer program according to claim 1, wherein the judging includes outputting any one of information about a computer that performed the communication and a communication status upon it is judged that the communication is executed by the worm.

8. The computer program according to claim 1, wherein the judging includes predicting a type of the worm by comparing features of a communication judged to be executed by a worm with features of a communication executed by a worm that is recorded in advance.

9. The computer program according to claim 1, causes the computer to perform cutting off the communication executed by the worm upon it is judged that the communication is executed by the worm.

10. The computer program according to claim 9, wherein the cutting off includes cutting off the communication executed by the worm by stopping a process that is started by the worm.

11. The computer program according to claim 9, wherein the cutting off includes cutting off the communication executed by the worm by making a fire wall function effective in a computer that is judged to have a worm.

12. A computer-readable recording medium for storing a computer program for detecting a worm by monitoring a communication of a predetermined network segment that is connected to a network and judging whether the communication is executed by a worm, the computer program causing a computer to perform:
acquiring information related to a traffic and a communication address of a communication packet based on setting information; and
judging whether the communication is executed by the worm based on the information acquired and a predetermined judgment criteria.

13. A method for detecting a worm by monitoring a communication of a predetermined network segment that is connected to a network and judging whether the communication is executed by a worm, comprising:
acquiring information related to a traffic and a communication address of a communication packet based on setting information; and
judging whether the communication is executed by the worm based on the information acquired and a predetermined judgment criteria.

14. A device for detecting a worm by monitoring a communication of a predetermined network segment that is connected to a network and judging whether the communication is executed by a worm, comprising:
an acquiring unit that acquires information related to a traffic and a communication address of a communication packet based on setting information; and
a judging unit that judges whether the communication is executed by the worm based on the information acquired and a predetermined judgment criteria.

15. The device according to claim 14, further comprising a setting changing unit that changes the setting information upon it is judged by the judging unit that the communication is executed by the worm, wherein
the acquiring unit acquires the information based on the setting information after change.

16. The device according to claim 14, further comprising a setting changing unit that changes the judgment criteria upon it is judged by the judging unit that the communication is executed by the worm, wherein
the judging unit judges whether the communication is executed by the worm based on the information acquired by the acquiring unit and the setting information after change.

17. The device according to claim 14, wherein the judging unit judges that a communication from a computer that is in the predetermined network segment is executed by the worm when
there is an increase in number of communication packets as well as number of destination addresses of communication packets that are transmitted from the predetermined network segment to the outside.

18. The device according to claim 17, wherein the judging unit judges that a communication from a plurality of computer in the predetermined segment is executed by the worm when
a communication from a computer in the predetermined network segment is judged previously to be executed by the worm, and
the number of destination addresses of the communication packet that is transmitted from the predetermined network segment to the outside becomes greater than a number of destination addresses of a communication packet acquired when the communication is judged to be executed by the worm, and is transmitted from the predetermined network segment to the outside.

19. The device according claim 14, wherein the judging unit judges that a communication from a computer that is outside the predetermined network segment is executed by the worm when
there is an increase in number of responding communication packets corresponding to communication packets that are transmitted from outside to the predetermined network segment, and
there is an increase in number of sender addresses of the communication packets.

20. The device according to claim 14, wherein the judging unit judges outputs any one of information about a computer that performed the communication and a communication status upon it is judged that the communication is executed by the worm.
